(19) United States
(12) Patent Application Publication
(10) Pub. No.: US 2026/0287829 A1
(43) Pub. Date: Sep. 24, 2026

(54) OPTICAL FIBER CONNECTOR

(71) Applicant: FOCI FIBER OPTIC COMMUNICATIONS, INC., HSINCHU (TW)

(72) Inventors: CHUN-YING KUNG, HSINCHU (TW); PIN-SUNG WANG, HSINCHU (TW); CHUAN-WEI ZOU, China (CN); CHIH-KUANG HSIAO, HSINCHU (TW)

(21) Appl. No.: 19/086,235

(22) Filed: Mar. 21, 2025

(30) Foreign Application Priority Data
Feb. 27, 2025 (TW) 114202070

(51) Int. Cl. G02B 6/38

(52) U.S. Cl. CPC G02B 6/387

(57) ABSTRACT

An optical fiber connector is provided, including a connector body, a limiting shell, a traction shell, and a tail tube; connector body is for accommodating optical components, the limiting shell is sleeved on the periphery of the connector body and can move forward and backward along an axial direction, and the outer wall of the limiting shell has at least one convex portion; the traction shell is partially sleeved on the limiting shell, and the inner wall of the traction shell is provided with at least one latch slot toward the limiting shell, and the convex portion is located in the latch slot; the front end of the tail tube is connected to the traction shell, and when the tail tube is pulled away from the connector body, the tail tube can be driven by the traction shell to move the limiting shell.

### BACKGROUND OF THE INVENTION

### 1. Field of the Invention

The present invention relates generally to an optical fiber connection component, and more particularly, to an optical fiber connector which can be unlocked by pulling a tail tube.

### 2. The Prior Arts

In large computer rooms or data centers, optical fibers are often used for data transmission. Because the optical fibers in the computer room or data center are arranged very densely and the space is very small, it is difficult for personnel to directly touch the optical fiber connector to plug and unplug the optical fiber when repairing or replacing it, making the plugging and unplugging operation extremely inconvenient. Therefore, it is necessary to design a kit to facilitate staff to plug and unplug.

Multi Push On (MPO) connector is a multi-core connector that usually arranges 12 optical fibers in a row. The same MPO connector can support one or more rows of optical fibers. The MPO connector is small in size and has a large number of channels. It is currently a widely used product in optical fiber connection equipment. FIG. 1 shows an existing standard MPO optical fiber connector 1 and an optical fiber adapter 2 matched therewith. The optical fiber connector 1 includes a connector body 11, a limiting shell 12, a tail tube 13, and an optical fiber cable 14. The optical fiber cable 14 is connected to the connector body 11 and extends out through the tail tube 13. The limiting shell 12 is sleeved on the outer periphery of the connector body 11 and can move forward and backward along the axial direction. When the limiting shell 12 moves to different positions, the connection state switches between locked or unlocked respectively.

During the docking process between the optical fiber connector 1 and the optical fiber adapter 2, a buckle hook 21 is connected to the connector body 11. During the process, the limiting shell 12 can move back and then automatically reset by the internal spring. When reset, it is in a locked state. However, when unlocking, the limiting shell 12 must be pinched by hand to move it out of the locked position. Only then can the optical fiber connector 1 be unplugged from the optical fiber adapter 2. In the current environment where optical fibers are densely arranged, it is difficult for a user to directly reach the limiting shell 12 with bare hands, thereby making the process of unplugging the optical fiber connector 1 more difficult.

### SUMMARY OF THE INVENTION

A primary objective of the present invention is to provide an optical fiber connector, with a design that can release the connection state of the optical fiber connector by pulling the tail tube, and is more convenient in assembly and operation.

To achieve the aforementioned objective, the present invention adopts the following technical solutions:

The present invention provides an optical fiber connector, comprising: a connector body, a limiting shell, a traction shell, and a tail tube, the limiting shell is sleeved on the periphery of the connector body and can move forward and backward along an axial direction, and the outer wall of the limiting shell has at least one convex portion; the traction shell is partially sleeved on the periphery of the limiting shell, and the inner wall of the traction shell is provided with at least one latch slot toward the limiting shell, and the convex portion of the limiting shell is located in the latch slot of the traction shell, so that the traction shell and the limiting shell can move synchronously; the front end of the tail tube is connected to the traction shell, and when the tail tube is pulled away from the connector body, the tail tube can be driven by the traction shell to move the limiting shell.

As one of the better preferred embodiments, the outer wall of the limiting shell also has a positioning groove and is adjacent to the convex portion, and the inner wall of the traction shell has a protruding hook and is adjacent to the latch slot, and the hook contacts the convex portion and extends into the positioning groove.

As one of the preferred embodiments, the positioning groove is a through hole, so that the convex portion has a thinner inner wall surface facing the connector body, and the end of the hook has a barb section, which extends to contact the inner wall surface.

As one of the preferred embodiments, the traction shell includes a first shell and a second shell; the inner walls of the first shell and the second shell are both provided with a latch slot, and the first shell and the second shell are connected to each other through a snap-fit structure.

As one of the more preferred embodiments, the outer wall of the front end of the tail tube has an annular groove, the first shell has a first arc wall at the corresponding position, and the second shell also has a second arc wall at the corresponding position; after the first shell and the second shell are docked together, the first arc wall and the second arc wall are enclosed in the area of the annular groove.

As one of the better preferred embodiments, the outer wall of the front end of the tail tube has a plurality of protruding blocks, the first shell has a plurality of first grooves at corresponding positions, and the second shell has a plurality of second grooves at corresponding positions; after the first shell and the second shell are docked together, the plurality of protruding blocks are respectively located in the first grooves and the second grooves.

As one of the better preferred embodiments, the first shell and the second shell form a U-shaped cross-section in longitude direction, and the snap-fit structure is that the first shell has a first embedding groove and a second embedding groove on both side walls of the U-shape, respectively, and the second shell has a first embedding member and a second embedding member on both side walls of the U-shape, respectively; after the first shell is docked with the second shell, the first embedding member is located in the first embedding groove, and the second embedding member is located in the second embedding groove, so that the first shell and the second shell are tightly combined together.

As one of the preferred embodiments, the wall thickness of the position where the second embedding groove and the second embedding member are located is greater than the wall thickness of the position where the first embedding groove and the second embedding member are located, and the second embedding groove and the second embedding member are located adjacent to the tail tube.

As one of the better preferred embodiments, the connector body includes an accommodating shell, a ferrule connector, a shell spring, and a fixing member; the accommodating shell has a chamber for a ferrule connector to be placed in and partially exposed through one end of the accommodating shell; the shell spring is arranged in the chamber and presses against the ferrule connector; one end of the fixing member has two elastic clips that can be inserted into the chamber and restrict the shell spring in the chamber and the other end of the fixing member away from the elastic clip has a wire tube.

As one of the preferred embodiments, a restoration spring is provided between the two sides of the limiting shell and the connector body for returning the limiting shell to its original position after movement, and two ends of the restoration spring respectively press against the limiting shell and the connector body.

Compared with the prior art, the optical fiber connector of the present invention can utilize the traction shell to drive the limiting shell to move when the tail tube is pulled away from the connector body, thereby ultimately achieving the purpose of unlocking the connection state of the optical fiber connector. Therefore, there is no need to manually grasp the limiting shell to unlock it as in the conventional structure. In addition, the traction shell is fixed by a snap-fit buckle between the first shell and the second shell, which is beneficial to the convenience of the assembly process and makes the product easier to produce and manufacture.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is an exploded view of a conventional MPO optical fiber connector and an optical fiber adapter.

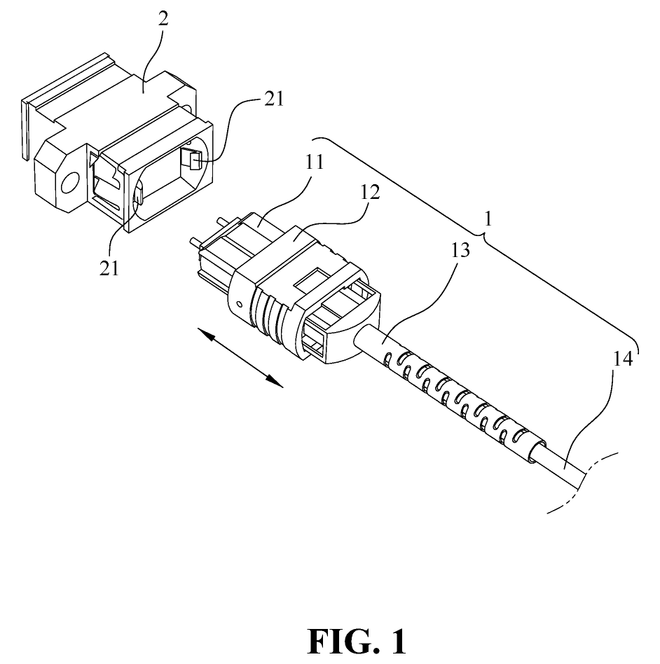

FIG. 2 is a perspective view of the first embodiment of the present invention.

FIG. 3 is an exploded view of the connector body, the traction shell, and the tail tube according to the first embodiment of the present invention.

FIG. 4 is an exploded view of the limiting shell and the connector body of the first embodiment of the present invention.

FIG. 5 is a schematic partial cross-sectional view of the first embodiment of the present invention.

FIG. 6 is a perspective view of the first embodiment of the present invention in which the tail tube is pulled to move the limiting shell.

FIG. 7 is a partial cross-sectional view of the second embodiment of the present invention.

FIG. 8 is an exploded view of the second embodiment of the present invention.

### DETAILED DESCRIPTION OF THE PREFERRED EMBODIMENT

The technical solutions of the present invention will be described clearly and completely below in conjunction with the specific embodiments and the accompanying drawings. It should be noted that when an element is referred to as being "mounted or fixed to" another element, it means that the element can be directly on the other element or an intervening element may also be present. When an element is referred to as being "connected" to another element, it means that the element can be directly connected to the other element or intervening elements may also be present. In the illustrated embodiment, the directions indicated up, down, left, right, front and back, etc. are relative, and are used to explain that the structures and movements of the various components in this case are relative. These representations are appropriate when the components are in the positions shown in the figures. However, if the description of the positions of elements changes, it is believed that these representations will change accordingly.

Unless otherwise defined, all technical and scientific terms used herein have the same meaning as commonly understood by one of ordinary skill in the art of the present invention. The terminology used herein is for the purpose of describing particular embodiments only and is not intended to limit the present invention. As used herein, the term "and/or" includes any and all combinations of one or more of the associated listed items.

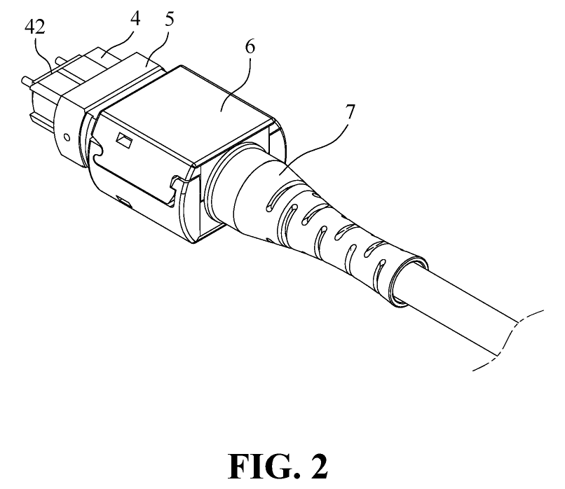

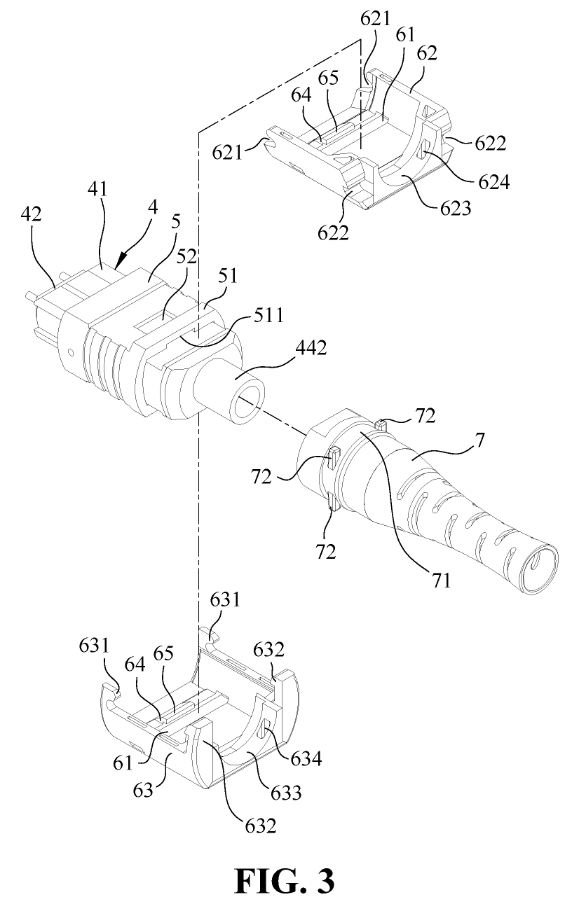

FIGS. 2 and 3 show a perspective view and an exploded view of the first embodiment of the present invention, respectively. The optical fiber connector of the present invention includes a connector body 4, a limiting shell 5, a traction shell 6, and a tail tube 7. The connector body 4 is where the optical transmission component is set and is used to connect with an optical fiber adapter to achieve the purpose of optical signal transmission. The limiting shell 5 is sleeved on the periphery of the connector body 4 and can move forward and backward along the axial direction. The outer wall of the limiting shell 5 has at least one convex portion 51; the traction shell 6 is partially sleeved on the periphery of the limiting shell 5, and the inner wall of the traction shell 6 has at least one latch groove 61 facing the direction of the limiting shell 5, and the convex portion 51 is located in the latch slot 61, so that the limiting shell 5 and the traction shell 6 can be linked to move synchronously; the front end of the tail tube 7 is connected to the traction shell 6, and when the tail tube 7 is pulled in a direction away from the connector body 4, the tail tube 7 is driven by the traction shell 6 to move the limiting shell 5, so as to achieve the purpose of unlocking the connection state of the optical fiber connector by pulling the tail tube 7.

Next, the structure of each component of the invention is described in detail:

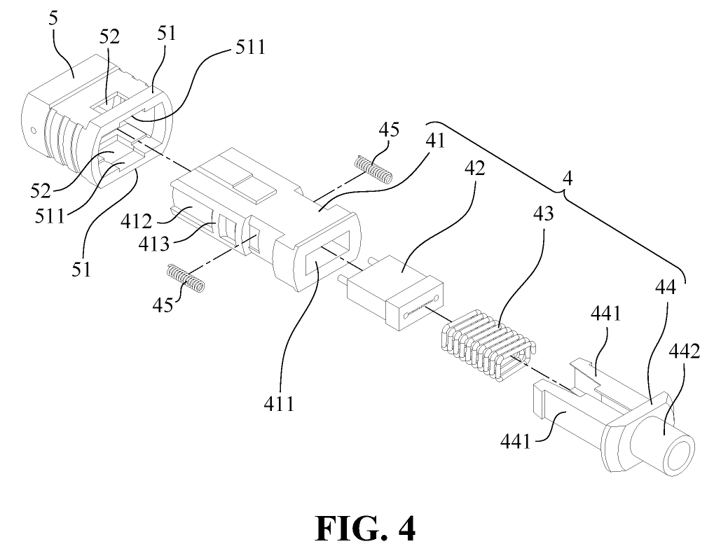

As shown in FIG. 4, the optical fiber connector of the present invention is of the specification of an MPO connector. The connector body 4 includes an accommodating shell 41, a ferrule connector 42, a shell spring 43, and a fixing member 44. The accommodating shell 41 has a chamber 411 therein, the ferrule connector 42 is placed in the chamber 411 and is partially exposed through one end of the accommodating shell 41 (as shown in FIG. 2), the shell spring 43 is disposed in the chamber 411 and abuts against the ferrule connector 42, one end of the fixing member 44 has two elastic clips 441 and can be inserted into the chamber 411 for fixing, so as to limit the shell spring 43 in the chamber 411, and the other end of the fixing member 44 away from the elastic clips 441 has a wire tube 442, so that the optical fiber cable (not shown in FIG. 3) can enter the accommodating shell 41 through the wire tube 442 and be coupled to the ferrule connector 42. The thinner outer walls on both sides of the accommodating shell 41 are respectively provided with a guide groove 412 and a convex rib 413 for docking with the hook of the optical fiber adapter and buckling after docking.

The limiting shell 5 is a hollow tubular shell. The limiting shell 5 is placed on the outer periphery of the accommodating shell 41 and can move forward and backward along the axial direction for a short distance but cannot be separated. Two restoration springs 45 are provided between the two sides of the accommodating shell 41 and the limiting shell 5. The two ends of the restoration spring 45 respectively press against the inner wall of the limiting shell 5 and the outer wall of the accommodating shell 41 of the connector body 4. The restoration spring 45 allows the limiting shell 5 to move and automatically return to its original position. The above structure is a standard structure of the MPO connector, so it will not be described in detail.

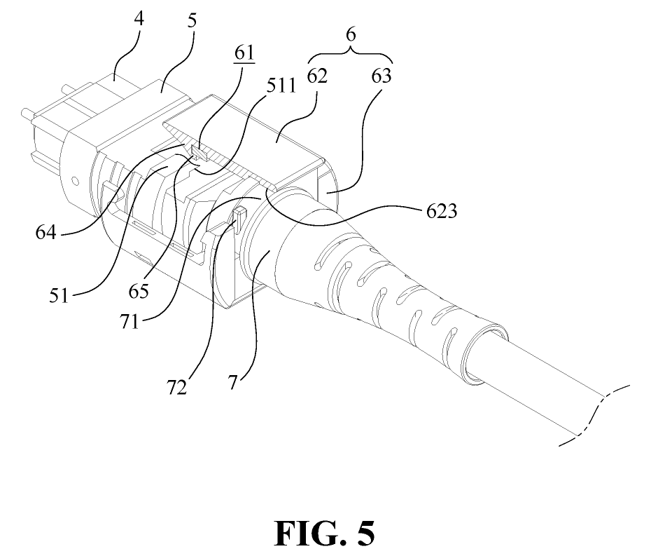

Refer to FIGS. 3 and 5. The design of the present invention is to have at least one convex portion 51 on the outer wall of the limiting shell 5. In the present embodiment, two convex portions 51 are provided and are respectively located at symmetrical positions on the outer walls of both sides of the limiting shell 5. The convex portion 51 is long and protrudes from the surface of the wider outer wall of the limiting shell 5. In addition, in the present embodiment, the outer wall of the limiting shell 5 further is disposed with a plurality of positioning grooves 52, which can be through holes and are adjacent to the convex portion 51, so that the convex portion 51 has a thinner inner wall surface 511 facing the connector body 4.

The traction shell 6 is a hollow tubular shell, with two ends respectively connected to the limiting shell 5 and the tail tube 7. For the convenience of assembly, in the present embodiment, the traction shell 6 has a two-piece structure, including a first shell 62 and a second shell 63. The inner walls of the first shell 62 and the second shell 63 are both provided with the latch slot 61. The longitudinal sections of the first shell 62 and the second shell 63 are U-shaped shells, so that the two are connected to form a tubular shell. In addition, the inner walls of the first shell 62 and the second shell 63 also have a protruding hook 64, which is adjacent to the latch slot 61. The end of the hook 64 also has a barb section 65. After assembly, the hook 64 will contact the vertical side wall of the convex portion 51 and extend into the positioning groove 52. The barb section 65 will contact the inner wall surface 511. In this way, the traction shell 6 can surely drive the limiting shell 5 to move.

The first shell 62 and the second shell 63 are connected to each other through a snap-fit structure. In the present embodiment, the snap-fit structure is that the first shell 62 has a first embedding groove 621 and a second embedding groove 622 on both side walls of the U-shaped shell. The height, shape and wall thickness of the first embedding groove 621 are different from those of the second embedding groove 622. The second shell 63 also has a first embedding member 631 and a second embedding member 632 with different wall thicknesses on both side walls of the U-shaped shell. After the first shell 62 and the second shell 63 are connected, the first embedding member 631 is located in the first embedding groove 621, and the second embedding member 632 is located in the second embedding groove 622, so that the first shell 62 and the second shell 63 can be tightly combined together. In addition, since the wall thickness of the position where the second embedding groove 622 and the second embedding member 632 are located is greater than the wall thickness of the position where the first embedding groove 621 and the first embedding member 631 are located, the traction shell 6 and the tail tube 7 are more firmly combined together.

The front end of the tail tube 7 is connected to the traction shell 6 after the first shell 62 and the second shell 63 are connected. The tail tube 7 is movably sleeved on the outer periphery of the wire tube 442. The front end wall of the tail tube 7 has an annular groove 71 and a plurality of protruding blocks 72. In the present embodiment, the protruding blocks 72 are protruding above the annular groove 71, but the present invention is not limited thereto. The two positions can also be separately arranged. The first shell 62 has a first arc wall 623 and a plurality of first grooves 624 at corresponding positions, and the second shell 63 also has a second arc wall 633 and a plurality of second grooves 634 at corresponding positions. When the first shell 62 and the second shell 63 are docked, the first arc wall 623 and the second arc wall 633 are enclosed in the groove space of the annular groove 71, and the plurality of protruding blocks 72 are respectively located in the first grooves 624 and the second grooves 634, so that the front end of the tail tube 7 is connected to the traction shell 6. The material of the tail tube 7 is softer than that of the traction shell 6. The diameter of the tail tube 7 is larger than the outer diameter of the optical fiber cable. When the tail tube 7 is pulled, the optical fiber cable passing through the inside does not move synchronously.

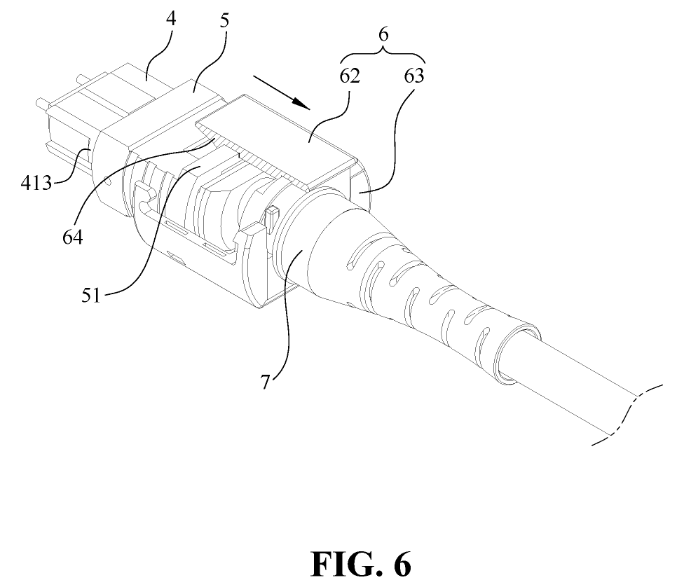

In the connection operation between the optical fiber connector and the optical fiber adapter, one end of the ferrule connector 42 of the connector body 4 is inserted into the optical fiber adapter, and the hooks on both sides of the optical fiber adapter respectively enter along the guide grooves 412 at both ends of the accommodating shell 41 and finally hook onto the convex rib 413. During the process, the limiting shell 5 first retreats and then automatically restores, so that the optical fiber connector is docked with the optical fiber adapter and is in a locked state. As shown in FIG. 5, the design of the present invention is that when the optical fiber connector is to be unplugged, the tail tube 7 can be directly pulled to move away from the connector body 4. Since the convex portion 51 is located in the latch slot 61, the traction shell 6 will pull the limiting shell 5 to move synchronously. As shown in FIG. 6, as the limiting shell 5 gradually moves away from the position of the convex rib 413, the hook is no longer surrounded by the limiting shell 5, and the optical fiber connector can be easily unplugged from the optical fiber adapter, thereby achieving the purpose of releasing the connection state of the optical fiber connector by pulling the tail tube 7.

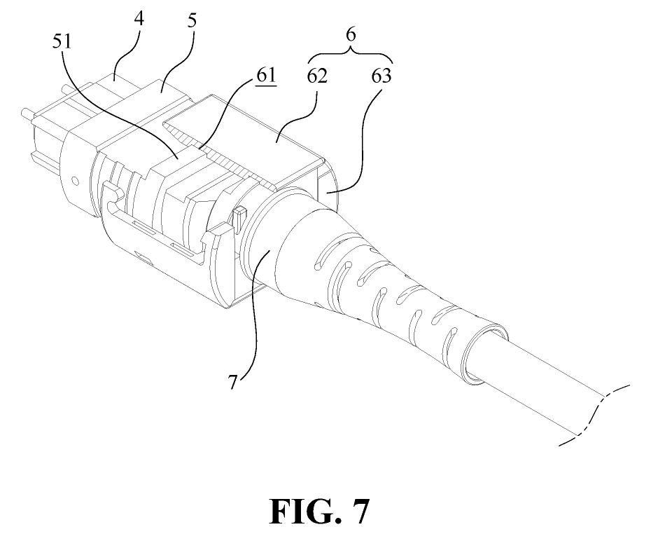

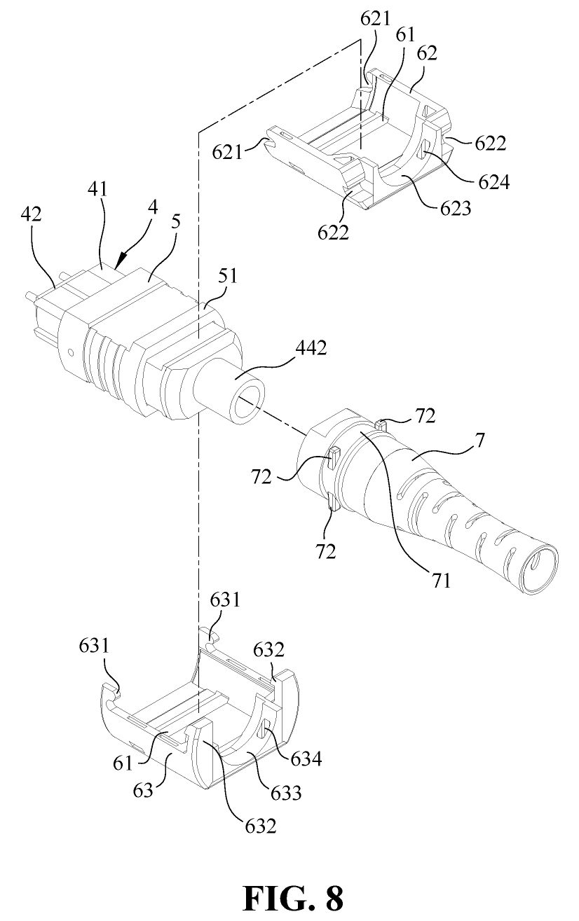

As shown in FIGS. 7 and 8, which are respectively a partial cross-sectional view and an exploded view of the second embodiment of the present invention, the optical fiber connector of the present invention still includes the connector body 4, the limiting shell 5, the traction shell 6, and the tail tube 7. The difference is that the outer wall of the limiting shell 5 only has the convex portion 51 and does not have the positioning groove 52 structure, and the first shell 62 and the second shell 63 of the traction shell 6 only have the latch slot 61 and do not have the hook 64 structure. The other structures are still the same as the first embodiment. The second embodiment can also achieve the purpose of releasing the connection state of the optical fiber connector by pulling the tail tube 7.

In summary, the present invention allows the user to pull the tail tube 7 to utilize the traction shell 6 to link the limiting shell 5 and move the limiting shell 5 away from the connector body 4, thereby achieving the purpose of unlocking. In this way, in an environment where optical fibers are densely arranged in a computer room or data center, there is no need to worry about the problem of being unable to unlock the connection state due to the inability to reach the limiting shell 5, making the plugging and unplugging of the optical fiber connector easier and faster.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An optical fiber connector, comprising:
a connector body;
a limiting shell, sleeved on the periphery of the connector body and able to move forward and backward along an axial direction, and the outer wall of the limiting shell being disposed with at least one convex portion;
a traction shell, partially sleeved on the periphery of the limiting shell, and the inner wall of the traction shell being disposed with at least one latch slot toward the limiting shell, and the convex portion of the limiting shell being located in the latch slot of the traction shell, so that the traction shell and the limiting shell able to move synchronously; and
a tail tube, with a front end connected to the traction shell, and when the tail tube being pulled away from the connector body, the tail tube being driven by the traction shell to move the limiting shell.

2. The optical fiber connector according to claim 1, wherein the outer wall of the limiting shell also has a positioning groove and is adjacent to the convex portion, and the inner wall of the traction shell has a protruding hook and is adjacent to the latch slot, and the hook contacts the convex portion and extends into the positioning groove.

3. The optical fiber connector according to claim 2, wherein the positioning groove is a through hole, so that the convex portion has a thinner inner wall surface facing the connector body, and the end of the hook has a barb section, which extends to contact the inner wall surface.

4. The optical fiber connector according to claim 1, wherein the traction shell includes a first shell and a second shell; the inner walls of the first shell and the second shell are both provided with a latch slot, and the first shell and the second shell are connected to each other through a snap-fit structure.

5. The optical fiber connector according to claim 4, wherein the outer wall of the front end of the tail tube has an annular groove, the first shell has a first arc wall at the corresponding position, and the second shell also has a second arc wall at the corresponding position; after the first shell and the second shell are docked together, the first arc wall and the second arc wall are enclosed in the area of the annular groove.

6. The optical fiber connector according to claim 4, wherein the outer wall of the front end of the tail tube has a plurality of protruding blocks, the first shell has a plurality of first grooves at corresponding positions, and the second shell has a plurality of second grooves at corresponding positions; after the first shell and the second shell are docked together, the plurality of protruding blocks are respectively located in the first grooves and the second grooves.

7. The optical fiber connector according to claim 4, wherein the first shell and the second shell form a U-shaped cross-section in longitude direction, and the snap-fit structure is that the first shell has a first embedding groove and a second embedding groove on both side walls of the U-shape, respectively, and the second shell has a first embedding member and a second embedding member on both side walls of the U-shape, respectively; after the first shell is docked with the second shell, the first embedding member is located in the first embedding groove, and the second embedding member is located in the second embedding groove, so that the first shell and the second shell are tightly combined together.

8. The optical fiber connector according to claim 7, wherein the wall thickness of the position where the second embedding groove and the second embedding member are located is greater than the wall thickness of the position where the first embedding groove and the second embedding member are located, and the second embedding groove and the second embedding member are located adjacent to the tail tube.

9. The optical fiber connector according to claim 1, wherein the connector body includes an accommodating shell, a ferrule connector, a shell spring, and a fixing member; the accommodating shell has a chamber for a ferrule connector to be placed in and partially exposed through one end of the accommodating shell; the shell spring is arranged in the chamber and presses against the ferrule connector; one end of the fixing member has two elastic clips that can be inserted into the chamber and restrict the shell spring in the chamber and the other end of the fixing member away from the elastic clip has a wire tube.

10. The optical fiber connector according to claim 1, wherein a restoration spring is provided between the two sides of the limiting shell and the connector body for returning the limiting shell to its original position after movement, and two ends of the restoration spring respectively press against the limiting shell and the connector body.
